(19) United States
(12) Patent Application Publication
(10) Pub. No.: US 2024/0311278 A1
(43) Pub. Date: Sep. 19, 2024

(54) METHOD FOR AUTOMATED ADAPTATION OF SOFTWARE TESTS

(71) Applicant: Robert Bosch GmbH, Stuttgart (DE)

(72) Inventor: Safouane Sfar, Pfullingen (DE)

(21) Appl. No.: 18/438,304

(22) Filed: Feb. 9, 2024

(30) Foreign Application Priority Data
Mar. 13, 2023 (DE) 10 2023 202

(51) Int. Cl. G06F 11/36

(52) U.S. Cl. CPC G06F 11/368

(57) ABSTRACT

A method for automated adaptation of software tests of a software. The method includes ascertaining a deviation specification which indicates a difference between at least two versions of the software; ascertaining an error specification about an error that occurred during an execution of the software test of the software; carrying out an evaluation of the deviation specification and the error specification with respect to a correlation of the error that has occurred and the difference between the versions of the software; generating an adaptation specification based on the carried out evaluation, wherein the adaptation specification specifies at least one item of information for adapting the software test to eliminate the error.

### CROSS REFERENCE

The present application claims the benefit under 35 U.S.C. § 119 of German Patent Application No. DE 10 2023 202 223.0 filed on Mar. 13, 2023, which is expressly incorporated herein by reference in its entirety.

### FIELD

The present invention relates to a method for automated adaptation of software tests. The present invention also relates to a computer program, a device and a storage medium for this purpose.

### BACKGROUND INFORMATION

Conventionally, automated execution of test cases can be provided as a part of software tests. Test cases can be checks that test the reaction of a software system to unexpected or incorrect inputs. These tests are in particular designed to identify potential error source in the software that lead to crashes or unexpected behavior. In addition to software functions, a software user interface can be checked as well.

However, if an element on a current user interface or the function being tested cannot be found in a software test process, the remaining steps of the process may be skipped or the entire testing process may fail. It is also possible that the individual step will fail and the process continues with the next step, which, because of the missing preceding step, will in turn most likely fail as well. The execution of the test process may therefore be made more difficult in such situations and possibly require manual intervention.

### SUMMARY

The present invention related to a method, a computer program, a device, and a computer-readable storage medium. Features and details of the present invention will emerge from the disclosure herein. Features and details which are described in connection with the method according to the present invention will of course also apply in connection with the computer program according to the present invention, the device according to the present invention, and the computer-readable storage medium according to the present invention and vice versa, so that mutual reference is or can always be made with respect to the disclosure of the individual aspects of the present invention.

The present invention includes a method for automated adaptation of at least one software test of a software. The software test is carried out on the software to check functions and/or a software user interface, for example. However, it is possible that the software test was created for an older version of the software and elements of the software have been removed in a current version. This can lead to the occurrence of an error when the software test is executed.

The method according to an example embodiment of the present invention can include the following steps, which are preferably carried out one after the after and/or repeated and/or in an automated and/or computer-assisted manner:
ascertaining a deviation specification which indicates a difference between at least two versions of the software, preferably a current and a previous version of the software, wherein the deviation specification preferably provides a different code of the versions, preferably by listing the different code,
ascertaining an error specification about an error that occurred during an execution of the software test of the software, wherein the error specification preferably provides an error type and/or a time of the error and/or an executed test case and/or an input and/or output of the software when the error occurred,
carrying out an evaluation of the deviation specification and the error specification with respect to a correlation of the error that has occurred and the difference between the versions of the software, preferably via a classification of the difference and/or the error,
generating an adaptation specification based on the carried out evaluation, wherein the adaptation specification specifies at least one item of information for adapting the software test to eliminate the error.

The present invention can thus have the advantage that it reduces the manual effort required to identify the cause of a test error. Depending on the cause of the error, the execution of the test steps can possibly also be automatically adapted to the current version of the software in order to eliminate the error. This enables a more robust execution of software tests to ensure that software can handle errors and unexpected situations.

Test cases are an important component of software tests and are used to ensure that the software works correctly and reliably. A test case for software test can be defined by a specific instruction and/or by a set of steps. The instruction and/or the steps can describe what is to be tested, i.e. in particular objects and/or functions of a software, and/or how it is to be tested and/or what results are expected. First, a test objective for the test case can be specified and the test conditions defined. What is to be tested, including the actions that have to be carried out to achieve the test objective, in particular step by step, can be defined for the test case as well. The expected results for the test case can then be defined. In practice, however, in such test cases errors often occur when an object or function undergoes a code change that affects the parameters used to identify the object or function. According to the method according to the present invention, such changes in the difference between the versions and/or such errors can in particular be detected during the evaluation, for example by means of a classification. Examples of such changes include changing the name parameter, changing the type of an object, or changing the parent container. If an object or function has changed, identification of the element can fail and the test may carry out unintended actions, which can lead to a cascade of errors. Adapting and maintaining such changes traditionally requires a considerable amount of investigation, updating and repetition of successive tests to verify the corrected test case.

According to the method according to an example embodiment of the present invention, machine learning (ML) can advantageously be used to enable adaptation and thus possibly self-recovery of the software test and/or classification during test automation execution, in particular if the error occurred due to a code change. As soon as a potential error occurs during test execution, an analysis of this error can be carried out using the described evaluation to determine whether the error is related to a code change (evaluation with respect to the correlation between the error and the difference between the versions). If this is the case, readapting the test case script as much as possible can be attempted in order to resume normal test execution. If the test execution then recovers from the unexpected state, this can be reported. A software tester can then assess whether the adaptation was valid. Based on this, the software tester can also approve that the adaptation be permanently included in the test script if appropriate, or can manually update the test script for the changed conditions.

It can optionally be possible that the at least two versions of the software include a current version and a previous version of the software, wherein the error occurred during execution of the software test in the current version of the software. In such cases, it can be possible that the execution of the evaluation is triggered, possibly in an automated manner.

In the context of the present invention, a further advantage can be achieved if the adaptation of the software test is carried out at least partially automatically on the basis of the adaptation specification, wherein the adaptation includes removing and/or adapting at least one test case and/or code of the software test which refers to elements of the current version of the software that have been removed from the previous version, wherein the elements preferably include to-be-tested functions and/or elements of a user interface and/or objects of the software. The at least partial or complete adaptation can be made possible by a machine learning model, for instance, which has been trained to predict a code change for the software test based on the adaptation specification.

According to an example embodiment of the present invention, it can furthermore be provided that a classification of the difference between the versions is carried out in the evaluation, preferably for detecting code changes in the software that are likely to cause the error to occur. The classification can be carried out using machine learning and/or pattern recognition algorithms, for example.

A further advantage can be achieved in the context of the present invention if the evaluation and/or generation of the adaptation specification is based at least in part on machine learning. The present invention can thus provide the advantage that, even if an element of a user interface and/or function being tested has not been found, the capabilities of machine learning (ML) are used in an automated manner to maintain the test sequence or restore a test that has failed as a result.

In the context of the present invention it can be provided that a machine learning model is provided. According to an example embodiment of the present invention, the machine learning model is trained by the following steps for evaluating and/or generating the adaptation specification:
ascertaining training data, wherein the training data include example deviation specifications about a respective difference between at least two versions of the software and example error specifications about a respective error during execution of the software test of the software, and wherein the training data include annotation data that provide reference adaptation specifications which specify the at least one item of information for adapting the software test to resolve the respective error,
initializing weights of the machine learning model,
carrying out a training process to optimize the weights of the machine learning model based on the training data, wherein the training process uses a loss function that minimizes a difference between the data generated by the machine learning model and the annotation data.

The training can be carried out using supervised learning for example.

According to an example embodiment of the present invention, it is also possible that continuous learning of a machine learning model is provided during repeated execution of the evaluation and/or generation, preferably on the basis of the thereby ascertained deviation and error specifications, preferably by means of retraining in which the ascertained deviation and error specifications are incorporated into the training data, and/or by means of incremental learning. It is thus possible for the machine learning model to improve itself. In other words, the machine learning model can be configured to be self-learning in order to learn during use.

The present invention also relates to a computer program, in particular a computer program product, comprising instructions that, when the computer program is executed by a computer, prompt said computer program to carry out the method according to the present invention. The computer program according to the present invention thus brings with it the same advantages as have been described in detail with reference to a method according to the present invention.

The present invention also relates to a data processing device which is configured to carry out the method according to the present invention. The device can be a computer, for example, that executes the computer program according to the present invention. The computer can comprise at least one processor for executing the computer program. A non-volatile data memory can be provided as well, in which the computer program can be stored and from which the computer program can be read by the processor for execution.

The present invention can also relate to a computer-readable storage medium, which comprises the computer program according to the present invention and/or instructions that, when executed by a computer, prompt said computer program to carry out the method according to the present invention. The storage medium is configured as a data memory such as a hard drive and/or a non-volatile memory and/or a memory card, for example. The storage medium can be integrated in the computer, for instance.

The method according to the present invention can moreover also be configured as a computer-implemented method.

Further advantages, features and details of the present invention will emerge from the following description, in which embodiment examples of the present invention are described in detail with reference to the figures. The features mentioned herein can each be essential to the present invention individually or in any combination.

### BRIEF DESCRIPTION OF THE DRAWINGS

FIG. 1 shows a schematic visualization of a method, a device, a storage medium and a computer program according to embodiment examples of the present invention.

FIG. 2 shows a schematic illustration of further details of the method according to embodiment examples of the present invention.

### DETAILED DESCRIPTION OF EXAMPLE EMBODIMENTS

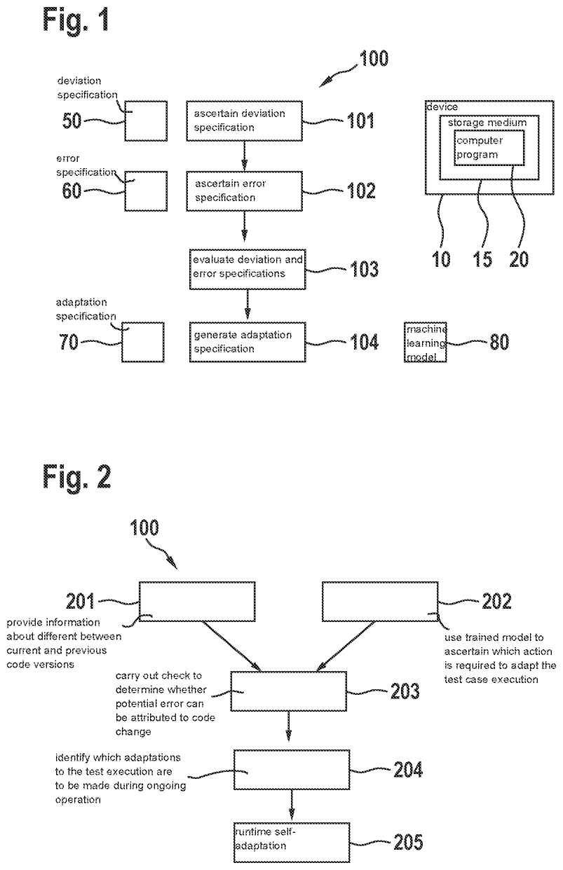

FIG. 1 schematically shows a method 100, a device 10, a storage medium 15 and a computer program 20 according to embodiment examples of the present invention. The shown method steps of the method 100 are used for the automated adaptation of software tests. According to a first method step 101, a deviation specification 50, which indicates a difference between at least two versions of the software is ascertained. Then, according to a second method step 102, an ascertainment of an error specification 60 about an error that occurred during an execution of the software test of the software can be provided. According to a third method step 103, an evaluation of the deviation specification 50 and the error specification 60 with respect to a correlation of the error that has occurred and the difference between the versions of the software is carried out. In a fourth method step 104, this makes it possible to generate an adaptation specification 70 based on the carried out evaluation 103. The adaptation specification 70 can specify at least one item of information for adapting the software test to eliminate the error. The correlation can be taken into account in the evaluation 103 using machine learning, for instance, in particular by providing a classification of such differences which may be the cause of the occurrence of the error. This can include deleted elements in a program code of the software, for example. Based on this, the adaptation specification 70 can be generated; possibly also using machine learning. This includes a result of the classification, for example, such as information about the deleted elements and/or a suggested change to adapt the software test. Continuous learning of a machine learning model 80 can be provided during repeated execution of the evaluation 103 and/or generation 104, preferably on the basis of the thereby ascertained deviation and error specifications 50, 60.

In the method 100 according to embodiment examples of the present invention, it can be provided that a test execution is initiated first. It is possible here to recognize that a potential error may occur. It can then be checked, in particular using machine learning algorithms such as the described machine learning model 80, whether this potential error can be associated with a code change. For this purpose, the machine learning algorithm can, for instance, provide one of the following possible outputs as a result of the classification and/or as the adaptation specification 70:
The error can be attributed to a code change and can be corrected automatically,
The error can be attributed to a code change and cannot be eliminated automatically,
A notification to the software tester that the cause of the error cannot be known.

The execution of the test scripts can be adapted during ongoing operation to the extent possible in accordance with this output. A software tester can also be informed, in order to determine whether the change is acceptable. The proposed method 100 therefore has the advantage that a termination of a test execution campaign can be prevented if an alternative is available. It can also be an objective of an adaptive automated test to directly link test scripts to changes to the software being tested.

FIG. 2 shows the method 100 according to embodiment examples of the present invention with further details. According to a step 201, information about the difference between the current code version used for the test and the previous one can be provided to a machine learning algorithm as a prerequisite. This can be done by classifying the differences and learning from the feedback about the classification. According to a further step 202, a trained model 80 can be used to ascertain which action is required to adapt the test case execution in accordance with a code change. This action can include removing code that refers to deleted elements, for example, or expanding the test for the new elements. According to a further step 203, a check can be carried out to determine whether the potential error can be attributed to a code change. This can include a review of test protocols to understand the cause of the potential problem. This can also include a comparison with previous protocols (from an earlier version of the code). According to step 204, it is possible to identify which adaptations to the test execution are to be made during ongoing operation. Then, according to step 205, a runtime self-adaptation can be carried out and, if necessary, the software tester can be informed. This allows the test campaign execution to continue.

The machine learning model 80 can include at least one artificial neural network, for instance; for example a convolutional neural network or CNN. Another option is the use of a recurrent neural network (RNN) because these are particularly well suited for processing sequences such as text or time series. The training can be carried out using backpropagation, for example, in order to thus adapt the weights in the artificial neural network. The model 80 is trained on the training data by making the predictions based on the input data, for example, and then adapting the weights using backpropagation to achieve a better match with the annotation data. The agreement can be checked using a cost function, for instance. The mean squared error (MSE) is used as the cost function, for example; preferably a categorical cross-entropy. A ReLU activation function can moreover be used for the hidden layers and the Softmax activation function for the output layer.

The above explanation of the embodiments describes the present invention solely within the scope of examples. Of course, individual features of the embodiments can be freely combined with one another, if technically feasible, without leaving the scope of the present invention.

What is claimed is:

1. A method for automated adaptation of at least one software test of a software, comprising the following steps:
ascertaining a deviation specification which indicates a difference between at least two versions of the software;
ascertaining an error specification about an error that occurred during an execution of the software test of the software;
carrying out an evaluation of the deviation specification and the error specification with respect to a correlation of the error that has occurred and the difference between the versions of the software; and
generating an adaptation specification based on the carried out evaluation, wherein the adaptation specification specifies at least one item of information for adapting the software test to eliminate the error.

2. The method according to claim 1, wherein the at least two versions of the software include a current version of the software and a previous version of the software, wherein the error occurred during execution of the software test in the current version of the software.

3. The method according to claim 2, wherein the adaptation of the software test is carried out at least partially automatically based on the adaptation specification, wherein the adaptation includes removing and/or adapting at least one test case and/or code of the software test which refers to elements of the current version of the software that have been removed from the previous version of the software, wherein the elements include to-be-tested functions and/or elements of a user interface and/or objects of the software.

4. The method according to claim 1, wherein a classification of the difference between the at least two versions is carried out in the evaluation, for detecting code changes in the software that are likely to cause the error to occur.

5. The method according to claim 1, wherein the evaluation and/or the generation of the adaptation specification is based at least in part on machine learning.

6. The method according to claim 5, wherein, a machine learning model is provided, wherein the machine learning model is trained by the following steps for the evaluating and/or the generating of the adaptation specification:
ascertaining training data, wherein the training data include example deviation specifications about a respective difference between at least two versions of the software and example error specifications about a respective error during execution of the software test of the software, and wherein the training data include annotation data that provide reference adaptation specifications which specify the at least one item of information for adapting the software test to resolve the respective error;
initializing weights of the machine learning model; and
carrying out a training process to optimize the weights of the machine learning model based on the training data, wherein the training process uses a loss function that minimizes a difference between data generated by the machine learning model and the annotation data.

7. The method according to claim 6, wherein continuous learning of a machine learning model is provided during repeated execution of the evaluation and/or the generation, based on the basis of the thereby ascertained deviation and error specifications, retraining in which the ascertained deviation and error specifications are incorporated into the training data, and/or by incremental learning.

8. A device for data processing, configured for automated adaptation of at least one software test of a software, the device configured to:
ascertain a deviation specification which indicates a difference between at least two versions of the software;
ascertain an error specification about an error that occurred during an execution of the software test of the software;
carry out an evaluation of the deviation specification and the error specification with respect to a correlation of the error that has occurred and the difference between the versions of the software; and
generate an adaptation specification based on the carried out evaluation, wherein the adaptation specification specifies at least one item of information for adapting the software test to eliminate the error.

9. A non-transitory computer-readable storage medium on which are stored instructions for automated adaptation of at least one software test of a software, the instructions, when executed by a computer, causing the computer to perform the following steps:
ascertaining a deviation specification which indicates a difference between at least two versions of the software;
ascertaining an error specification about an error that occurred during an execution of the software test of the software;
carrying out an evaluation of the deviation specification and the error specification with respect to a correlation of the error that has occurred and the difference between the versions of the software; and
generating an adaptation specification based on the carried out evaluation, wherein the adaptation specification specifies at least one item of information for adapting the software test to eliminate the error.
